(19) United States
(12) Patent Application Publication
(10) Pub. No.: US 2005/0286715 A1
(43) Pub. Date: Dec. 29, 2005

(54) Modularized network phone device having various replaceable user interfaces

(76) Inventors: Hoay-Lye Cheah, Taipei (TW); Shih-Hsiung Weng, Taipei (TW)

Correspondence Address: EDWARDS & ANGELL, LLP, P.O. BOX 55874, BOSTON, MA, 02205, US

(21) Appl. No.: 10/871,184

(22) Filed: Jun. 18, 2004

(51) Int. Cl. H04M 1/00; H04M 9/00

(52) U.S. Cl. 379/428.01

(57) ABSTRACT

The present invention provides a modularized network phone device suitable for a network system having at least an Internet connection, which comprises a main module having at least one I/O interface that is used to receive and transfer analog signals through the network system from and to a remote modularized network phone device and, at least a user interface module having at least one I/O connection port connecting I/O interface and, being detachably coupled to the main module and a user, to enable the user interface module, by a replacing method, to connect to the main module. Wherein, the user interface module can be a monochrome or color display screen having a touch-sensing function, and also can have a video transferring function.

### FIELD OF THE INVENTION

The present invention relates to network phone devices and, more particularly, to a modularized network phone device provided with a user interface.

### DESCRIPTION OF THE PRIOR ART

Voice over Internet Protocol (VoIP) technology is provided to digitize analog voice signals into voice signal packets to be immediately transferred over the Internet that uses the Internet Protocol (IP). As the Internet has already been established and distributed to the public, there exists no need for setting up an additional line for exclusively transferring the voice signal packets. Further, VoIP technology is used for data transmission by converting analog voice signals into voice signal packets for being transferred over the Internet. Thus, it is obviously much lower in cost compared to the data switching carried out via the conventional telecommunication architecture.

At present, the VoIP technology has been so developed that a user does not need to utilize and operate a standard computer connected to the Internet and running specialized software in order to carry on telecommunication with a remote user. Instead, network phones having no operational differences from conventional phones have been developed, as shown in FIG. 1. This type of network phones is capable of processing and transmitting analog voice signals by digitizing, compressing and packetizing the voice data into voice data packets. It thus allows the voice data packets to be transmitted via the Internet to a remote network phone, and, to be processed, decompressed and converted back to analog voice signals for a user to conduct telephony with a remote user of the remote network phone via the Internet.

FIG. 1 shows a perspective view of a conventional network phone. As illustrated in FIG. 1, a conventional network phone typically consists of a main body 10 for processing the voice signals of a phone call and a display screen 12, which acts as a user interface between the network phone and a user of the network phone integrally formed with the main body 10. In this design, the display screen 12 can not be dismantled or detached from the main body 10.

However, with the rapid advancement of technology, network phones with a user interface provided with various functions have become possible and commercially available, in order to meet with consumers' needs and desired marketing purposes. For example, a user interface of a network phone can now display images in high resolution in multiple colors or provide users with touch functionality, in addition to conventional display functions, such as text display, numeric display, and graphic display.

There thus exists a drawback of the aforementioned conventional network phone that, due to the inseparability of the display screen and the main body, consumers are unable to upgrade or add new functionality to the network phones currently in use by simply replacing the display screen with a new one. This means that consumers either need to spend considerably extra money to replace their equipment to meet with their needs, or, to forego the advantages available with new technology. Consequently, the flexibility and operational lifespan of the current style of network phones are greatly adversely affected. Moreover, the manufacturers of network phones are required to spend more time and money to develop network phones with new or upgraded functionality, because the structural design of a network phone always needs to be altered as a whole. This not only wastes resources but also causes manufacturers inflexibility in responding to market needs.

### SUMMARY OF THE INVENTION

The objective of the present invention is to provide a modularized network phone device that can be upgraded and added with new features at a lower cost and in a mere convenient way to implement as compared with the prior art.

In order to achieve the above and other objectives of the present invention a modularized network phone device suitable for a network system having at least an Internet connection is provided. The modularized network phone device comprises a main module having at least one I/O interface that is used to receive and transfer analog signals through the network system from and to a remote modularized network phone device, and at least a user interface module detachably coupled to the main module by connecting at least an I/O connection port of the user interface module with the I/O interface of the main module, so as for the user interface module to serve as the user interface between the main module and the user.

The objectives, characteristics and efficacies of the present invention, for those skilled in the art, are detailed by the brief description of the preferred embodiments and drawings that follow.

### BRIEF DESCRIPTION OF THE DRAWINGS

FIG. 1 is a perspective view of a conventional network phone;

FIG. 2A is a schematic diagram showing the I/O interface to be attached to the main module according to an embodiment of the modularized network phone of the present invention;

FIG. 2B is a front view of the modularized network phone according to the present invention showing the I/O interface attached with the main module.

FIG. 3 is a block diagram showing the main module of the modularized network phone illustrated in FIG. 2A and FIG. 2B;

FIG. 4 is a block diagram of a first preferred embodiment of the user interface module of the modularized network phone according to the present invention;

FIG. 5 is a block diagram of a second preferred embodiment of the user interface module of the modularized network phone according to the present invention;

FIG. 6 is a block diagram of a third preferred embodiment of the user interface module of the modularized network phone according to the present invention.

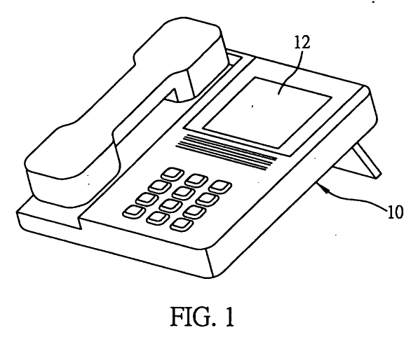

### DETAILED DESCRIPTION OF THE PREFERRED EMBODIMENTS

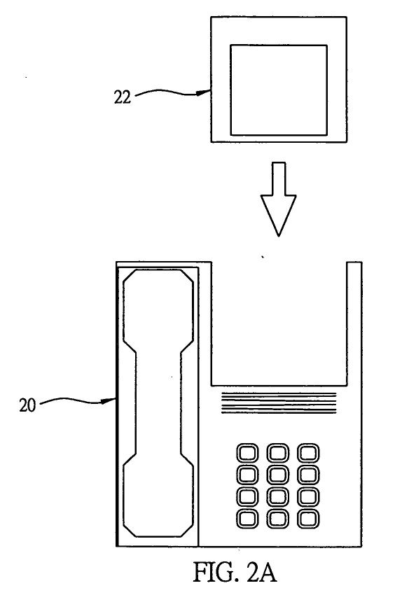

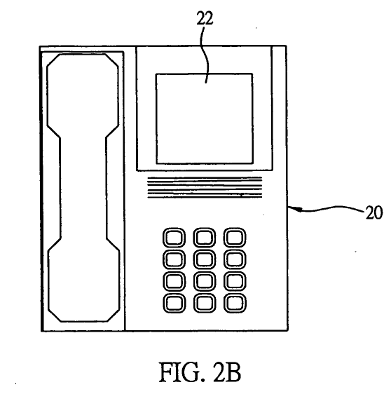

FIG. 2A shows that the modularized network phone of the present invention consists of a main module 20 and a user interface module 22, which is detachably coupled to the main module 20. The main module 20 is provided with at least one I/O interface (not shown) that is used to receive and transfer analog signals through the network system to and from a remote modularized network phone device. The user interface module 22 also has at least one I/O connection port (not shown) for electrically connecting to the I/O interface (not shown) of the main module 20, and is detachably coupled to the main module 20. It is noted that the modularized network phone of the present invention is suitable for a network system having at least an Internet connection. Such a network system is usually formed by the Internet and the public-switched telephone network (PSTN), or by the Internet and a mobile communication network, and can also be formed by PSTN and mobile communication network in possible combination with the Internet.

As shown in FIG. 2B, as the user interface module 22 can be attached to or assembled with the main module 20, it allows a user to easily replace the user interface module with a new one, without the need for changing or discarding the main module. Thus, the network phone can be upgraded in performance or augmented with new functionality in a more convenient way and at a lower cost than the prior art.

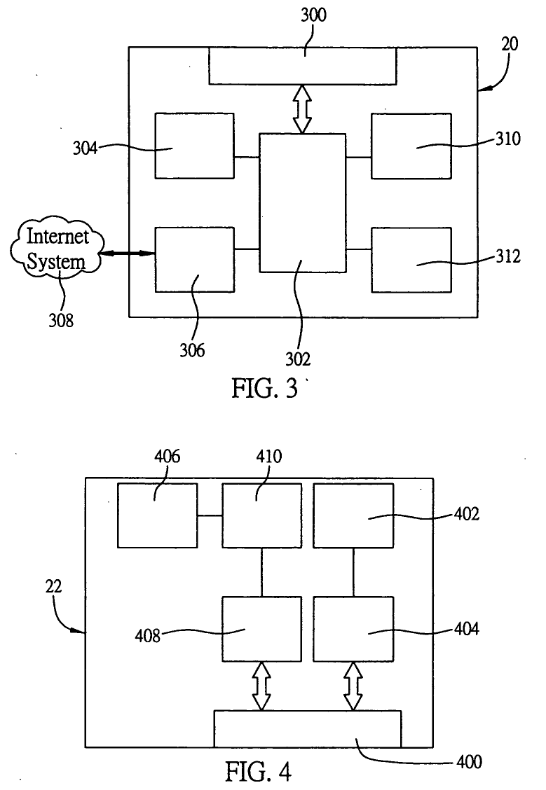

Referring to FIG. 3, the main module 20 includes an I/O interface 300, a main control unit 302, a voice interface unit 304, a network interface unit 306, a communication network 308, a memory unit 310, and an input unit. The voice interface unit 304 is used to receive an analog voice signal input by a user via a handset (not shown) interface module 22, and convert the analog voice signal into a digital voice data, which the network interface unit 306 passes to the electrically coupled communication network 308 after the data has been broken into voice signal packets. The main control unit 302 is provided for communicating with the user interface module 22 via the I/O interface 300, allowing the digital voice signal received from the voice interface unit 304 to be processed by the main control unit 302 into corresponding voice packets to be then transmitted to the communication network 308 via the network interface unit 306, and for allowing the voice signal packets received by the network interface unit 306 via the communication network 308 to be converted into corresponding digital voice data by the main control unit 302, so that the digital voice signal can be transmitted to a user via the voice interface unit 304 after conversion to an analog signal. Further, the memory unit 310 is electrically connected to the main control unit 302 for storing signal information processed by the main control unit 302. And, the input unit 312 that connects to the main control unit 302 allows a user to communicate with the main control unit 302 via the input unit 312.

FIG. 4 shows a first preferred embodiment of the user interface module 22 of the modularized network phone device according to the present invention. The user interface module 22, as shown in FIG. 4, is a monochrome display screen with touch-sensing functionality used to display signal information transferred by the main module 20, such as text data, numeric data, symbol data, graphic data, etc, and allowing users to input the commands into the user interface module 22 by a touch method. The user interface module 22 includes an I/O connection port 400, a monochrome liquid crystal display unit 402, a control unit 404, a touch screen 406, a complex programmable logic device (CPLD) 408, and a touch-function control unit 410. The monochrome liquid crystal display unit 402 is used to display information transferred by the main control unit 302 of the main module 20. The control unit 404 is connected to the monochrome liquid crystal display unit 402 and the main control unit 302 of the main module 20 via the I/O connection port 400, for driving the monochrome liquid crystal display unit 402 upon receipt of commands from the main control unit 302. As to the touch screen 406, it is used for a user to touch to generate commands to be sent to the main control unit 302. The complex programmable logic device (CPLD) 408 communicates with the main control unit 302 of the main module 20 via the I/O connection port 400. It allows the main control unit 302 to receive input when the touch screen 406 is touched after the touch sensations are processed by the CPLD 408 for sending to the main control unit 302. The touch-function control unit 410 connected with the touch screen 406 and CPLD 408, is used to drive the CPLD 408 to respond to the touch screen 406 which is touched.

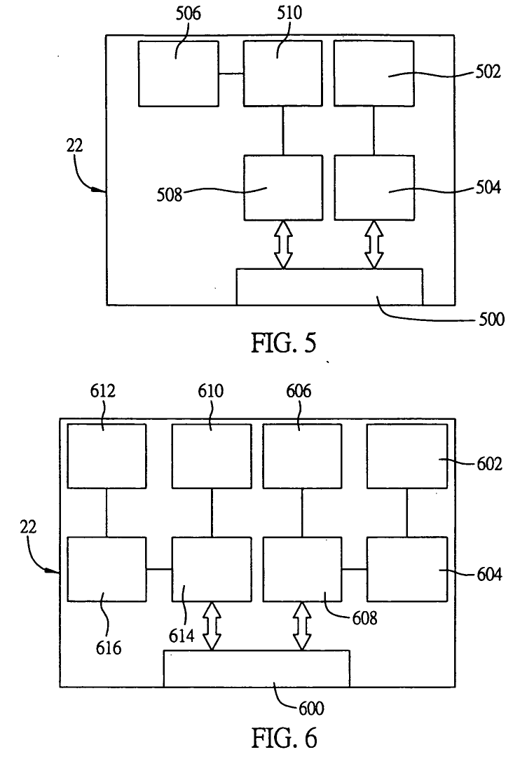

FIG. 5 shows a block diagram of the second preferred embodiment of the user interface module of the modularized network phone device according to the present invention.

The user interface module 22, as shown in FIG. 5, has a color display screen with touch functionality used to display information transferred by the main module 20, such as text data, numeric data, symbolic data, graphic data, etc, and it allows users to input commands into the user interface module 20 by a touch method. The user interface module 22 includes an I/O connection port 500, a color liquid crystal display unit 502, a control unit 504, a touch screen 506, a complex programmable logic device (CPLD) 508, and a touch-function control unit 510. The color liquid crystal display unit 502 is used to display information transferred by the main control unit 302 of the main module 20. The control unit 504 is connected to the color liquid crystal display unit 502 and the main control unit 302 of the main module 20 via the I/O connection port 500, for driving the color liquid crystal display unit 502 upon receipt of commands from the main control unit 302. As to the touch screen 506, it is used for a user to touch to generate commands to be sent to the main control unit 302. The complex programmable logic device (CPLD) 508 connects the main control unit 302 of the main module 20 via the I/O connection port 500. It allows the main control unit 302 to receive input when the touch screen 506 is touched, after the touch sensations have been processed by the CPLD 508 for sending control signals to the main control unit 302. The touch-function control unit 510, connecting the touch screen 506 and CPLD 508, is used to drive the CPLD 508 to respond to the touch screen 506 when touched.

FIG. 6 shows a block diagram of a third preferred embodiment of the user interface module of the modularized network phone device according to the present invention.

The user interface module 22, as shown in FIG. 6, is a color display screen with touch functionality and an image display function, which are used to display the information transferred by the main module 20, such as image data, text data, numeric data, symbolic data, graphic data, etc, and allow users to input commands into the user interface module 20 by a touch method. Thus, by using the network phone equipped with user interface module 22, as shown in FIG. 6, images of the opposite remote user can be shown, and the system can also be used for video conferencing, providing that the systems are equipped with image-capture devices. The user interface module 22 includes an I/O connection port 600, a color liquid crystal display unit 602, a control unit 604, an image-capturing device 606, an image processor 608, a driving motor 610, a touch screen 612, a complex programmable logic device (CPLD) 614, and a touch-function control unit 616. The color liquid crystal display unit 602 is used to display information and images transferred by the main control unit 302 of the main module 20. The control unit 604 is connected to the color liquid crystal display unit 602 and the main control unit 302 of the main module 20 via the I/O connection port 600, for driving the color liquid crystal display unit 602 upon receipt of commands from the main control unit 302. The image-capturing device 606 is used to take images of objects or scenes. The image processor 608 is electrically connected to the control unit 604 and the image-capturing device 606, allowing the images taken by the image-capturing device 606 to be processed by the image processor 608. The driving motor 610 is used to adjust the focus of the image-capturing device 606. The touch screen 612 is used to allow a user to touch-generate commands to be sent to the main control unit 302. The complex programmable logic device (CPLD) 614 is connected to the driving motor 610 and the main control unit 302 of the main module 20 via the I/O connection port 600. It allows the main control unit 302 to receive when the touch screen 612 is touched, after the touch sensations are processed by the CPLD 614 for sending a control signal to the driving motor 610 and the main control unit 302. The touch-function control unit 616 connecting the touch screen 612 and CPLD 614 is used to drive the CPLD 614 to operate to respond to the touch screen 612 which is touched.

For manufacturers, by utilizing the design of the modularized network phone device of the present invention, they do not need to abandon the existing designs, and also do not need to change the structure of main module 20, but rather, can concentrate on developing and improving the design of user interface module 22.

For the consumer, by using the modularized network phone device of the present invention users can spend less money to upgrade the existing devices by changing the user interface module 22 of the network phone.

The main module 20 of the network phone device in the present invention can have at least an I/O interface, but can also be collocated with various user interface module 22, thus, the network phone device of the present invention has good expandability.

The above description is only illustration of the better embodiments; it is not intended to limit the scope of substantially technique content of the present invention. The substantially technique content of the present invention defines widely in the following “claims”, if any substantial technique and method accomplished by others are the same as the description of claims as followed or equivalent efficiency of modification, all will be seen as within the scope of the present invention.

1. A modularized network phone device suitable for a network system at least having an Internet connection which comprises:
a main module used to connect analog signals to digital signals to be transferred to a remote modularized network phone device and, convert digital signals received from the network system to analog signals to be transferred via at least an I/O interface of the main module; and
at least a user interface module coupled to the main module by connecting at least an I/O connection port of the user interface module with the I/O interface of the main module, allowing the analog signals to be transferred between the user interface module and main module via the connection of the at least an I/O connection port and I/O interface, wherein the user interface module serves as a user interface between the main module and a user.

2. The modularized network phone device as claimed in claim 1, wherein the network system further comprises a Public-Switched Telephone Network (PSTN).

3. The modularized network phone device as claimed in claim 1, wherein the network system further comprises a mobile communication network.

4. The modularized network phone device as claimed in claim 1, wherein the network system further comprises a Public-Switched Telephone Network (PSTN) and a mobile communications network.

5. The modularized network phone device as claimed in claim 1, wherein the main module further comprises:
a voice interface unit used to receive an analog voice signal input by a user via the at least one user interface module, and convert the analog voice signal into a digital voice signal;
a network interface unit coupled to a communication network and used to receive voice data packets;
a main control unit for communicating with the at least a user interface module via the I/O interface, allowing the digital voice data received from the voice interface unit to be processed by the main control unit into corresponding voice data packets to be then transmitted to the communication network via the network interface unit and, allowing the voice data packets received by the network interface unit via the communication network to be converted into a corresponding digital voice signal by the main control unit to be transmitted to the user via the voice interface unit;
a memory unit connecting to the main control unit for storing signal information processed by the main control unit; and
an input unit connecting the main control unit for allowing the user to communicate with the main control unit via the input unit.

6. The modularized network phone device as claimed in claim 1, wherein the user interface module comprises:
a display unit used to display information received from or to be transferred to a main control unit of the main module; and
a control unit electrically connected to the display unit and the main control unit via the I/O connection port for driving the display unit upon receipt of commands from the main control unit.

7. The modularized network phone device as claimed in claim 5, wherein the user interface module comprises:
a display unit used to display information received from or to be transferred to the main control unit of the main module;
a control unit electrically connected to the display unit and the main control unit via the I/O connection port for driving the display unit upon receipt of the commands from the main control unit;
an image-capturing device for taking images of objects or scenes; and
an image processor electrically connected to the control unit and the image-capturing device, allowing the images taken by the image-capturing device to be processed by the image processor.

8. The modularized network phone device as claimed in claim 6, wherein the display unit is a monochrome liquid crystal display.

9. The modularized network phone device as claimed in claim 6, wherein the display unit is a color liquid crystal display.

10. The modularized network phone device as claimed in claim 6, wherein the information displayed by the display unit are text data, numeric data, symbolic data or graphic data.
